(19) United States
(12) Patent Application Publication
(10) Pub. No.: US 2012/0303439 A1
(43) Pub. Date: Nov. 29, 2012

(54) USER-DEFINED ACCESS CONTROLS FOR ACCESSING USER VIA AN ELECTRONIC COMMUNICATION DEVICE

(75) Inventors: Daniel Ian Flitcroft, Dublin (IE); Garry Lyons, Dublin (IE)

(73) Assignee: Sotxtme Ltd, Dublin (IE)

(21) Appl. No.: 13/522,146

(22) PCT Filed: Jan. 13, 2011
(86) PCT No.: PCT/IE2011/000002

§ 371 Date: Jul. 13, 2012

Related U.S. Application Data
(60) Provisional application No. 61/294,728, filed on Jan. 13, 2010.

(51) Int. Cl. G06F 15/16; G06Q 30/02

(52) U.S. Cl. 705/14.36; 709/204

(57) ABSTRACT

A system that controls what information can reach a user via an electronic or electrical communications device and under what circumstances is disclosed. The controls can be set by the user, e.g., an individual or an authorised person acting in a supervisory role. This provides a configurable communication inclusion and exclusion zone. Only communications that meet predefined or dynamically configured rules are presented to the user. These rules determine who can contact a user, when they can be contacted, where they can be contacted, with what message content and by which route. Users can thereby fully control how they receive communications or advertising messages. The platform also integrates payment capabilities to allow users to be paid for delivery of marketing messages with cash, cash equivalents, vouchers or premium media content such as news stories, music or films.

### FIELD OF THE DISCLOSED SYSTEM

A method and apparatus (i.e., “system”) for providing electronic communications, and in particular to a system for providing user-defined access control for communications to one or more user-controlled electrical communication devices.

### DESCRIPTION OF THE RELATED ART

Each wave of technological advance in communications has increased accessibility and generated new channels for dissemination of content (e.g., news, information, alerts, marketing and advertising to name a few). Compared to this seemingly unstoppable march of progress, relatively little has been done to insulate individuals from the consequences of near total accessibility to many people. Conversely, in relation to advertising, the increased number of channels now available for delivery of marketing messages is such that by over-exposure and saturation any messages relevant to interests risk being lost in the noise generated by the barrage of adverts an average person is exposed to each day. Despite technological advances in how information can be delivered, advertising and marketing messages are still generally presented to a broad audience rather targeted to the specific interests of a particular person. Progress in communication technology therefore represents two contrasting problems, firstly of how to protect people from a barrage of information and secondly of how to ensure people receive information that they are interested in receiving.

Some aspects of these two problems are common to a range of communication channels but there are specific issues with each channel. For example, the mobile phone has gained huge penetration throughout the world and has created a generation of young adults that have grown up expecting to be able to communicate with anyone at anytime. The many advantages of mobile phones are matched by a range of more negative aspects. These include added stresses of the expectation that individuals are always available, the intrusion into environments where mobile phones are considered inappropriate (e.g., theatres, restaurants, churches, etc.) and indeed the possibility of intrusion into every conversation or human interaction. Technologies such as push-to-talk technology increases further the potential for intrusion. The challenge is to balance the value of mobile telephony with the intrusional aspects of this technology. Simply turning off a mobile phone delivers privacy and freedom from unwanted intrusion but in many situations people would want to be contactable at least by some people or for important messages. In the current climate being without a mobile phone can be as stressful as being continuously accessible. The challenge is to provide technology that allows them to interact in a balanced manner with a caller and the physical situation or conversation they are currently in, and be assured that depending on their situation messages of sufficient importance can reach them.

The two issues highlighted above are probably most apparent in email communication with workers both overloaded by email which consumes an increasing proportion of each working day and so-called ‘spam’ email which broadcasts millions of largely irrelevant messages in an entirely untargeted manner simply because it is almost free and no fool-proof systems exist to prevent it. The combination of email and mobile technology for example as exemplified by ‘push-email’ technology in RIM's range of BLACKBERRY devices has made workers accessible to work related messages during all their waking hours. While legislation in Europe has limited working hours, it has not prevented work related emails being delivered outside the defined working period.

Text messaging (e.g., by IM, SMS or MMS for example) provides another channel. In many countries statutory and best practice regulations have prevented the uncontrolled development of marketing messages or spam by requiring that users opt-in to receive any information by text message. This has severely limited the development of advertising on mobile phones. For non-marketing communications, SMS messaging can be very intrusive as its rapid mode of delivery often leads to an expectation of a rapid response. Alerts for the delivery of text messages can also be intrusive both for the recipient and any others in the vicinity of the recipient's mobile device.

Media such as television and radio are intrinsically more opt-in activities and the impact of new technology relates more to advertising. Traditional broadcast media such as Radio and TV have maintained their traditional reliance on advertising but targeting is limited to general attributes of the audience for a particular channel or program. New technologies for digital streaming of video and audio content present new challenges and opportunities for content supported media delivery, in particular in relation to targeting the user with more relevant advertising.

The Internet has perhaps provided the largest expansion of daily information to individuals. Along with delivery of information there has been a massive development of online advertising, both banner advertising and the form of text related adverts popularized by GOOGLE. Much of this advertising is distracting and can be poorly targeted. As with TV and radio, it is often assumed that the profile of the viewer can be determined by the content of the page they are viewing. While this has proved a reasonable approximation it has not fully exploited the potential of much more highly customized approach whereby the user receives only advertising information that he or she is interested in receiving.

Highly targeted advertising is much more valuable from a marketing perspective and hence each advertisement is more valuable. As an advertiser or other content provider may be willing to pay more for such personalized access, this opens new opportunities to incentivize people to receive adverts, in essence paying people for intrusions into their privacy. Such payments can be in terms of money, vouchers, services (e.g. phone credit, data delivery), media content, etc. In many cases the most appropriate form of compensation relates to the communication device being user, i.e., phone credit for adverts delivered to a mobile phone, premium content such as movies or music with streamed media or TV, premium web content when accessing the Internet.

### BACKGROUND OF THE SYSTEM

Delivery of targeted advertising is well known but for many communication channels very broadly used in terms of times and proximity to specific types of TV program. Direct mail and online services can use customer information such as demographic data, prior purchase history, address to provide targeted information. A key feature absent from current forms of advertising is the provision of sufficient user control, so that an individual rather than an advertiser has ability of to decide what sort of advertising/marketing messages can be received, when, where and how.

For Internet users a range of privacy and site exclusion solutions. These cover spam prevention, pop-up blockers, website filters to eliminating sites with inappropriate content (at home or work). Email or spam protection services are directed to eliminating all or most unwanted marketing emails. Some are provided free but others are provided as a subscription service where the user must pay. With email accessibility through mobile devices throughout our waking hours, the burden of email extends beyond pure marketing messages, and what has not been provided for to date is the ability to provide much more sophisticated email filtering so emails of relevant content are delivered when, where and how the recipient chooses, in a dynamic way.

A range of solutions have been considered for controlling access and promoting privacy in voice communications. These include voice mail, call forwarding if busy or a call is not answered, Caller ID, provisions for different ring tones for different uses or silent vibration alerts. Vibration alerts in phones or BLACKBERRY-type devices are a valuable contribution to removing the noise of an incoming mobile call, but still require the breaking off a current activity to answer a call or look at the sender information and re line. The caller/sender can still not know how appropriate it is for the recipient to take a call, text message, email or other form of communication.

Environment sensing technology has been proposed where a series of sensors determine the activity of the user to see whether it is appropriate to receive a call, e.g., on the World Wide Web at cs.cmu.edu/˜aura/docdir/sensay_iswc.pdf. These relate to background sound levels or physical movement of the user but these are not always good predictors of the appropriateness of receiving a call. A user may for example be seated quietly in an office and ideally suited to receive a call or in a museum where it may be inappropriate to receive a call.

One specific application in the field of incentivized advertising for mobile devices is disclosed in WO 2008041871 (Advertising System and Method). This application discloses what would now be considered to be a standard advertising platform directed to deliver adverts to mobile devices. In relation to the question of protecting the recipient from inappropriate content the disclosure is notably lacking stating only that messages submitted by advertisers for inclusion in an advertising campaign may be checked by an administrator of the advertising system before approval for the campaign is given.

There is a perceived need for protecting the privacy of the recipient, ensuring compliance with local advertising regulation, protecting a consumer from misleading advertisements the process of advertising approval needs to be highly secure and resilient to human error.

Exemplary embodiments of the apparatus and methods to achieve some or all of these purposes are disclosed below.

### SUMMARY OF THE EXEMPLARY SYSTEM

Various embodiments of the presently disclosed system include inter alia a software platform and associated hardware devices that control access to communication devices of an individual by one or more communication channels for all communications including personal, work or advertising/marketing messages. This exemplary system controls what information can reach a user and under what circumstances by providing a configurable communication inclusion and/or exclusion zone to overcome ever increasing problems of information and marketing overload driven by advances in communication technology. Only communications that meet predefined or dynamically configured rules are presented to the user. These rules determine who can contact a user, when they can be contacted, where they can be contacted, with what message content and by which route. Users can thereby fully control how they receive communications or advertising messages.

Determination of acceptable message content can be determined by text analysis, speech recognition or provision of access codes for privileged users to break through an exclusion zone rule in the case of an emergency. Control of message content for advertising can controlled by both inclusion and exclusion criteria. These can be categories, classifications or topics chosen by the user, demographic, income, job or related interest of the user, for example. They can also be dynamically configured on the basis of information a user posts on social networking sites, location, search or browsing history.

The platform also integrates payment capabilities to allow users to be paid for delivery of marketing messages with cash or cash equivalents, credit, pre-loaded fund cards, premium subscription or subscriptions, vouchers, premium media content and discounts for products or services such as news stories, music or films. As described below there are certain variations in the operation of the platform depending on the type of message.

### Voice and Text Based Communications

Rather than receiving voice calls at any time, calls can be controlled so as to be received by the user only when and where the user determines it is suitable to receive them and may be otherwise responded to or re-routed without the involvement of the user according to pre-defined or dynamically configured rules. Call routing can be set according to time, receiving location, content, content provider (e.g. individual sender or business) or other conditions appropriate to a particular communication channel. In relation to content this is only known to the caller so the importance of the call can be determined by voice recognition for example by an automated messages that requests the caller to give a brief description or by asking the caller to input information through the key pad, e.g., if the caller has a particular priority, he or she may be asked to input a priority of call ranging from identifying the call as extremely urgent to asking for a response when convenient and if interested. That is, alternatively numeric or voice codes can be used to indicate the urgency of the call.

### Text Based Communications (SMS/MMS/Paging Technology/Email)

The same applies to text messaging and equivalent technologies. At present email is divided into normal and SPAM, but different classes have different priorities, e.g. work related, personal, relevant opt-in marketing messages, and priorities in each of these classifications. Delivery rules can be set according to time, receiving location, content and sender. Emails can be prioritized and delivered at appropriate times according to sender, content, location of the user and other user specified rules. The intrusive nature of “push-email” technology can be controlled by this platform to ensure a proper separation of work and home life. Configurable auto-responders can provide automated responses to the sender depending on the content indicating the likely for time frame for the recipient to reply to a given email. In addition the configuration rules provide for re-routing of certain emails to other recipients where appropriate. To prevent information related overload in the work place for instance, rules can be set up to ensure that if more than a threshold number of communications are received in a given period temporary blocks can be triggered with auto-responders indicating a person is being overloaded or simply unavailable so the sender should not expect an immediate reply.

### Advertising/Marketing Communications

A user can define an exclusion zone for content such as adverts and receive media content that has been automatically stripped of advertising and replaced by blank space, family photo's, music from their music library, video from their own video library or online source streaming video source such as YOUTUBE, content from other selected providers, or even other advertisements the user is interested in receiving. This can apply to web browsing, radio, Internet radio, television, streamed media, ebooks and any form of electronically delivered or broadcast media. In some situations this can be offered as a paid opt-out of advertising.

Advertising revenues are not typically shared with recipients and the recipient generally has no control over advertising (other than at a general level with opt-in or out-opt options on a provider-by-provider basis). In a reversal of normal advertising practice, the current system allows for the potential of users to opt to receive adverts by any available communication channel and be paid for viewing/hearing them. Rather than generally broadcast adverts, these users receive only adverts related to their chosen interests, location, demographic, etc. and at times, on channels, on devices and locations they have pre-selected. In this new paradigm users are paid in cash or cash equivalents or services, e.g., premium content from normal subscription websites such as some newspapers.

In order to ensure relevance and to ensure that profile data for a recipient is up to date, information can be extracted (with the user's permission) from social network sites, credit card providers, credit card networks (e.g., DISCOVER, AMEX, VISA or MASTERCARD), online banking sites or email accounts. Additional controls can ensure that for delivery to mobile digital devices, dynamic location data (e.g., GPS) can be used to ensure that advertising messages are only delivered in certain locations.

The ability to remove generic advertising from a range of communication media also generates the option of replacing with more appropriate adverts relevant to the user. In most cases main-stream media such as national newspapers or radio stations cannot successfully target a specific demographic due to their broad appeal and broadcast nature. Advert replacement or dynamic generation of personalized on-line newspapers or digitally streamed radio/TV allows national content to be combined with specific content based on a user's chosen interests, demographic data, interests, location, etc., generation and standard compliance process. Users can be paid for providing such data in cash or in the form of access to otherwise premium, paid-for, content.

### BRIEF DESCRIPTION OF THE DRAWING FIGURES

The present exemplary system will now be described by reference to the accompanying drawings in which like reference numbers refer to similar components through the figures.

FIG. 1 illustrates an exemplary system architecture and dataflow diagram of the presently disclosed system.

FIG. 2 is a flowchart illustrating the process of establishing user-based access controls on user communications devices.

FIG. 3 is a flowchart illustrating controlling access based on user-selected parameters.

FIG. 4 is a flowchart illustrating an advertisement review process.

FIG. 5 is a flowchart showing a user-controlled push-email service.

### DETAILED DESCRIPTION OF EXEMPLARY SYSTEMS

As described herein, a system is a generic term describing both methodologies or processes by which a user can define access to his or her communication devices, the hardware (e.g., communication devices, wireless and wired networks, servers, databases, computer processors that have been specifically programmed to become a specific purpose computer), both in terms of hardware, firmware, complied or executed software on communications devices, networks, computers, servers and databases and, of course, combinations thereof. Similarly, as used herein, the term “user” should be broadly understood to mean individuals, both individuals in a supervisory role (supervisors at places of employment, and/or parents, for instance) who may be able to implement controls on a device in the position of another user, e.g., an employee or a child, for instance. Further, the user can be someone such as an executive assistant, practice coordinator or communications officer who facilitates control of communications to another user, such as an executive, a doctor, politician, employer or other person that delegates these responsibilities to another.

The term “communication device” should encompass nearly all forms of communication devices including, but not limited to, smartphones, mobile phones, personal data assistants, email devices such as BLACKBERRY devices, PCs, Macs, laptops, tablet computers, televisions and radio sets that have unique identification or addresses for receiving electronic communications, or nearly any other communication device that has a unique identification or address that can be associated with a particular user so as to control the content received by the communication device according to criteria associated with the user. Further, “accessing” a communication device by a sender means the sender's messages will be permitted to be received in some form but perhaps not the original form at some time, either within normal timeframes for transmission of messages or after a delay or blackout period.

Also, communications between the user-devices, various databases and servers, content providers, content controllers, advertising agencies, users or any other entity involved in communication within the present system can be conducted through any suitable protocols, suitable communication systems that are electronically or optically based (that is, excluding pure human interaction, which should not be considered a system within the confines of this application). Also, as used herein, device-based communications means any form of communication over devices, whether electrical, optical (e.g., fiber optical), radiation modulation (radio frequency or other physical layers) but of course excluding pure human interaction that does not involve a physical communications device, and channels refers to a communication path that may be separated from other device-based communication either by protocol, hardware, software, or physical layers or nearly any other form of communication involving more than simple human interaction.

### System Implementation

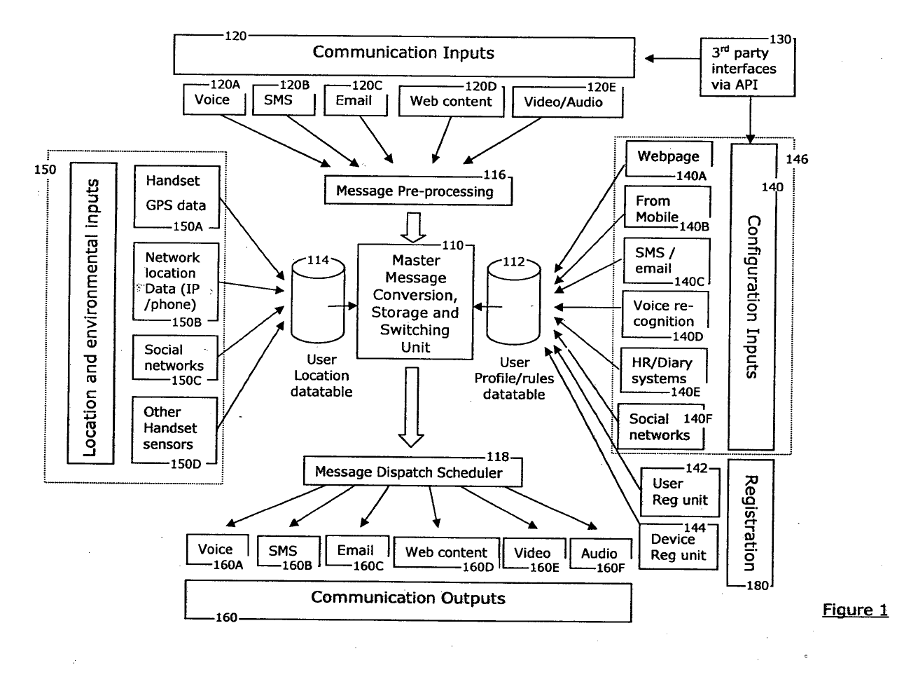

As shown in FIG. 1, a master message conversion, storage and switching unit 110 is at the center of an exemplary implementation of a system. This master unit 110 acts as an access control device or means for controlling access to at least one registered user communications device in accordance with selected user-defined parameters that set controls on access for communications to at least one registered user communications device. In this implementation, a master unit 110 may convert messages from one form to another, store them when appropriate and switch the routing from one channel and/or device to another, all based on user location, user profiles and user-defined rules as identified in the systems such as databases 112 and 114. That is, the master unit 110 is associated with the user location database 114, and a user profile/rules database 112. Here, as is conventional, these elements do not have to be co-located or even discrete devices. The master unit 110 can be divided among a number of computers and servers over a diverse geographic area, or centrally located in one location and even on one computer. The master unit 110 can be implemented using cloud computing, for instance, though of course security is a criteria. Similarly, the user location database 114 may be a single database, or may be drawn from several databases which may or may not be controlled as a single entity. For instance, the user location database, can be a database devoted to the master unit 110, but it can also be a location service, such as mobile telephoning providers offer as a services to provide the location of its subscribers for various purposes. Similarly, the user profile/rules database 112 can be centrally located or diversely located, and in an extreme example, can be on one or more of the user's devices. Further, the master unit 110 can be a discrete service available directly to individuals, or as a service bureau for other service providers (mobile telephony providers, ISPs, credit card companies, etc.) or agencies (e.g., first responders, military, or other government agencies).

Implementation of the master unit 110 will vary somewhat for different communication channels but a range of modular functions are included in its operation. These include:
1. Interface(s) for incoming messages,
2. Message interrogation and routing module(s),
3. Interface(s) for setting, reviewing and modifying routing rules,
4. Hardware devices to receive the location of a particular mobile communications device or user,
5. Database(s) for recording messages, content related data, rules, user information and preferences, and
6. Outgoing interface(s) for message routing.

With respect to the user location database 114, it is noted that the location and environmental inputs 150 provide the locations of the user to the database 114. The location and environmental inputs 150 can include one or more of various location and environmental input services. For instance, a handset can include a GPS device or functionality, thereby providing handset GPS data 150A directly or through the mobile communications provider. It should be noted here that GPS is but one way of detecting absolute geographic location. Network location 150B can be provided by Wi-Fi triangulation using Wi-Fi addresses, cellular tower location and cellular tower addresses to name two other ways. Additionally, the IP address of personal computers or home routers, for instance, can also be used to provide location information. Nearly any manner in which this information can be provided is acceptable.

Further, location and environmental inputs can be derived through social networks 150C. That is, the user can post his or her location on a social network such as FACEBOOK, which can be picked up and identified for use in the user location database 114. The user may also use TWITTER or other forms of social networking to identify his or her location. For instance, in TWITTER he or she could simply identify in a tweet “in a meeting” or “in church” to identify prescribed rules regarding these locations. Here, it should be noted that locations are often geographic in nature, but also can be by subject matter. For instance, the geographic location of a meeting may be less important than the fact that the person is in a meeting.

Further, the location and environmental inputs 150 should be broadly interpreted as also including inputs from various other sensors and data input devices. For instance, at a given location there may be beacons or other forms of automated communications that identify the location as not being suitable for certain forms of communication. For instance, in a theatre, a beacon can send out a broadcast message to all wireless communication devices alerting incoming telephone calls or texts and emails by sound is inappropriate, thus provoking a set of rules regarding same. On an airplane, any form of wireless communication is unwelcome during take off and landing. A broadcast message to this effect would at least prevent incoming messages from being received for those passengers who may forget to turn off their communication device. Further, other handset sensors 150D could include ambient sound or ambient motion sensors to deduce the activity of the user of the device. For instance, if the user of the device is detected as traveling at a relatively high rate of speed, it could be deduced that they are driving and therefore not available for wireless communications particularly if other inputs indicate this activity such as the user inputting an indication that motion should infer driving if such motion is primarily due to the person driving as opposed to being on a train or otherwise being a passenger.

Also included in FIG. 1 are communication inputs 120. As described herein, communications can reach users by a wide range of technologies: fixed line phone, mobile phone, email, pagers, radio, television, streaming digital media devices and computers. Due to the variation in technology, specific hardware and software interfaces will be required for each form of communication e.g. voice, SMS, MMS, email, radio, TV, Internet. Incoming messages are received via the appropriate existing network. On receipt of a message or message stream, raw content data is saved and the message is optionally analyzed to extract content information, either in a message pre-processing unit 116 or the master unit 110. Content processing is again specific to each communication channel. Depending on the nature of the incoming communications message content may be processed by a range of processing tools. These include text analysis (keyword or semantic processing) of text content, associated meta-information provided by the sender (i.e. hidden information not normally presented to the recipient), analysis of programming and scripting information (e.g., to determine the relevance of different elements within a webpage), automated voice-to-text processing or image analysis. The abstracted information of message source and content is saved in a database for processing in the message routing component.

The incoming messages interface or pre-processing 116 can be accessed for both specific messages addressed at a single user or for messages targeted at a range of users. In the latter case the range can either be based on a series of identifiers that specifically identifies individual members of a contact list or more generic group identifiers that can be used to identify appropriate recipients in terms of interests, location, etc. The choice of user identification depends on the application and type of communication. For example, specific identifiers or lists thereof relate more to personal and work communications and the demographic/location identifiers more to advertising/marketing communications. In the case of messages that are aimed at a specific demographic, a sender communicates with a dedicated interface to supply the message and can target a range of users by querying the database of all users to generate a list of suitable recipients according to their stored preferences.

Hence, communication inputs can be voice communication inputs 120A (e.g., telephone calls, push to talk communications, pushed voicemail or other forms of communication using voice). Another form of communication input 120 is SMS communications, which as used herein, should be read to include Instant Messages (IM), multimedia services (MMS), and paging technologies. Email 120C is another form of communication input 120, as is web content 120D. Further, video/audio communication inputs 120E include video streaming and audio streaming, for instance, but is not so limited.

Each of these communication inputs 120 can receive the same or separate treatment within the message preprocessing unit 116, through the master unit 110 according to user location and/or user profile and/or user-set rules before the message dispatch through a message dispatch scheduler 118.

The message dispatch scheduler 118 can dispatch messages by voice 160A, by SMS/MMS/IM 160B, by email 160C, by web content 160D, by video 160E or audio 160F through a communication output. It should be noted here that a communication input at communication inputs 120 may actually be of a different form than the output at communication outputs 160. That is, a voice message 120A might be converted to an SMS message 160B or an email 160C, or for that matter even web content 160D. Similarly, an input SMS, IM or MMS message 120B might be converted to voice by human or text-to-voice software, for instance. The same with email 120C, web content 120D. The basic point is one form of communication at communication inputs 120 can take on a different form of communication at communication outputs 160 via a user-defined rules in the master unit 110. Similarly, a communication intended for a telephone portion of a smartphone might actually access the individual through a data service that could be available in multiple locations, including the smart phone, a person's personal computer, pager, and the like. Similarly, an input communication might be converted into multiple forms, or multiple forms of inputs can be aggregated or otherwise combined to a single form of communication, for instance.

In addition to relying on the routing rules in force at a particular time, an option exists for a message sender to be automatically queried for further information. This allows potential ambiguities in message content to be resolved and ensure highly urgent messages are sent to the recipient. For example, if an email message is re-routed or stored for later delivery, the sender can be notified by email with a link indicating that if they feel the message has special urgency they can provide more information as to its importance. A user of the system can also provide certain contacts with priority codes that may be alphanumeric or voice based to allow them to override rule-based blocks on message delivery.

Once all required information has been obtained from message source, content and any additional codes or information supplied by the sender a decision module then implements the appropriate routing of a message. The options include but are not limited to: allowing the message to be delivered normally; storage for later delivery; re-routing to another recipient or routing to voice-mail.

When messages are stored the routing module will be required to monitor the status of relevant delivery rules. Once rules are altered to allow delivery, for example by a change in location of the recipient or the expiry of time-related block on certain types of messages, the message can then be delivered.

The final step of the process occurs when messages are dispatched from the routing module or dispatch scheduler 118 into the appropriate communication channel. In many cases outgoing messages are sent in the same communication channel (voice, email, etc.) but depending on rule configuration messages may be sent on in a different channel. In addition, message content may be split over several communication media. For example a voice call may be diverted to voice mail but an email or SMS may be sent with message content data to the recipient.

The specific embodiments described herein for particular forms of communications highlighting the specific features of each, but these can be combined in any combination to create a solution that operates across a range of communication media. This reflects the practical implementation aspects of this complex system. In implementing the system it is anticipated that a specific application (e.g. for voice communications or mobile advertising) may be completed first within the overall platform architecture and subsequently additional communication channels added over time.

Configuration inputs 140 involve a user registration device or means 142 that receives user information to register a user, a user communications device registration device or means 144 that receives user communications device registration to register at least one user communications device capable of receiving device-based communications in relation to the user, and a parameter setting device 146 that receives user-defined parameters from a registered user, the user-defined parameters setting controls on access for communications to at least one user communications device.

A significant ability of the present system, if fully implemented, is the ability to control all or nearly all aspects of device-based communication delivery. This requires a set of interfaces 146 for specifying communication rules. The principal interface device 146 for setting, reviewing and modifying routing rules is a text or graphical user interface operated by the recipient or upon his/her behalf. This interface will allow the user to select, review and modify rules based on form of communication (e.g. phone call, SMS, email, Internet, radio, TV etc), sender, content, priority, location, time etc. All rules are stored within the central database. Secondary interfaces can provide dynamic modification of these rules. For example, an interface 150 for receiving information on a user's location by GPS can be combined with existing information to dynamically modify rules so that messages are received only in appropriate or chosen locations. Secondary interfaces can communicate with diary, calendar or scheduling applications such as Microsoft Corporation's OUTLOOK to ensure the appropriate of receiving messages. Secondary interfaces can also be provided in hardware form as buttons or other selection devices on mobile devices to allow privacy modes to be enabled and disabled. In this case the device will directly communicate with the platform to alter the relevant routing rules when such a privacy mode button is selected.

In a corporate setting a manager or supervisor can optionally control the delivery rules for an individual or group or workers to ensure compliance with legal requirements or corporate policies regarding delivery of messages during and out of work hours. Rules can also be set relating to the frequency of communications to prevent information overload which can dramatically reduce working efficiency.

With respect to the configuration inputs 140, it is up to the user (meaning the user of the device, or someone filling a supervisory role) to register themselves, register one or more of their communications devices, and to configure user profiles as to who is sending the communication, what the content of the communication is, when the communication is to be received and how the communication should be routed to the user's device or devices. The configuration can include user-defined parameters of set controls for communications to at least one user communications device wherein the parameters include at least one selection of content provider parameters, at least one selection of each of content provider parameters, time period parameters, location parameters, content parameters, registered user communications devices when more than one device is registered, communication route parameter when more than one route is available to a user-defined device, an interrelationship controls or dynamic controls on selected parameters, as explained throughout this disclosure. The content can be provided by web pages 140A, SMS, email and other forms of text messaging 140B, via a mobile phone using either integrated hardware, via the phone's operating system or menu or using an application running on the mobile phone 140C, voice recognition 140D of telephone call content, HR/diary systems 140E such as employers setting time periods in which communication should or can be sent to an employee to comply with local regulations or internal criteria of the employer, and diary entries such as appointments on an OUTLOOK calendar, for instance. Further, social networks can provide meaningful content to both the user profile and rules database. That is, postings on social networks by the user can identify areas of interest and demographic information, and can be used as a source of identification of location of the user. Further, the social network can be an interface to provide the configuration inputs (e.g., the user-defined controls). That is, a person's social network page on, for instance, FACEBOOK, can be used as an interface to identify configuration inputs 140 for that particular user.

Finally, third party interfaces 130 via application program interfaces for instance can provide both a communication inputs 120 and the configuration inputs 140. That is, with respect to the above example, a social network site or any other form of interface used by user can provide inputs for the configuration 140, or inputs for communication 120 to a given user. That is, a user can go to his FACEBOOK page and define the various communication parameters and, a friend can then go on the same FACEBOOK page and send a communication to the user which would then go to the master unit 110 via the communication inputs 120 through a third party interface 130 in order to forward the communication to the user according to the user-defined parameters via the communication outputs 160 and in accordance with the location information provided by the location and environmental inputs 150.

An important feature of this implementation can be the ability to set access codes whereby a caller who has been given a Priority Access Code (PAC) by the recipient can use this to override certain privacy protections to ensure that critical messages can still be received.

### Examples of Different Privacy Zone Settings

Red or Lock Down Zone. No calls are received. All calls are redirected to other numbers or voice mail services. Text messages are only received if overridden by a Priority Access Code (PAC). In which case a text message, email or other alert summarizing call content and caller can be supplied.

Orange or High Privacy Zone. Only calls with PAC received all others diverted to message service. Texts are time delayed until a lesser privacy zone is selected unless they contain the PAC as the first characters.

Yellow or Privacy zone low. Only calls with PAC received all others diverted to message service. Texts can be received normally.

Green zone. Normal operation.

The interrelationship of these various components is further explained below.

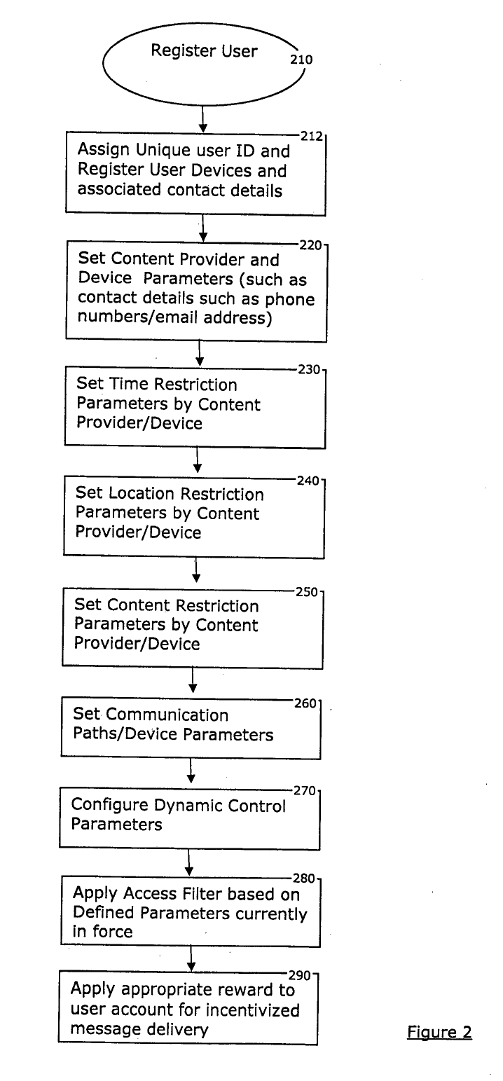

FIG. 2 illustrates an exemplary flow for user registration and establishment of user-based access control. As shown therein, step 210 includes registering a user for user-based access control. The user creates an account either on-line or via a mobile application or a series of interactive SMS messages, for instance. In partnership with a mobile operator, for instance, the creation of a user account for the present system could be linked with the creation of a mobile phone account or the purchase of a new phone handset, for instance. Other avenues for establishing an account are envisioned, particularly with respect to other devices wherein the provider of the user communications devices facilitates establishment of an account, e.g., the provider of a PC or a Mac or like devices could offer to establish the account as part of the initial set-up of the device and thereafter. As part of the registration process of the user, the user or seller of the communication device can identify the device itself and prompt the user to register one or more devices to the user. That is, the user might have a smartphone, a computer tablet, a PC, multiple mobile phones and landlines, each being set up so that separate rules or common rules can be established for each communications device. At least one user communications device is thus registered (step 212). The user is then prompted to choose content providers that are either identified as permitted content providers, preferred content providers or restricted content providers (step 220). The rules can be open-ended or closed-ended meaning that all content providers can be accepted except those that are restricted and the preferred content providers given the higher priority, for instance. It can also be closed-ended meaning that only the content providers that have been identified as acceptable are permitted to communication with the user's device by device basis or as a global rule.

As shown in step 230, time restrictions can be chosen as well. In this instance, time restriction includes both acceptable times and unacceptable times for receiving communications either in absolute terms or per priorities on the communication or the sender. For instance, in jurisdictions where regulations govern the number of hours an employee can work, after hours communications can be restricted. That is, if the location regulations forbid employees working after a particular hour of the day, such communications that relate to work after those hours can be blocked immediate transmission and delayed for receipt in the morning, for instance. Similarly, if the employee's activities are recorded in some manner, after a given period of time (e.g., an eight hour day) no matter what time of day, the restrictions can be placed. Of course, permissive rules are part of the time restrictions. That is, one can chose to affirmatively elect to receive communications only during certain hours. This includes receiving a given set or user defined number of communications within a certain time period.

In step 240, the user can select location-based restrictions. Here, geographic location can be used as a criteria, i.e., locations identified by mapping services as churches, for instance, may be selected as a category or on a location-by-location or category/classification basis for restricting communications. There may be permissive zones, such as an office where the restrictions might be very open or non-existent as to location, but nevertheless can have restrictions on events, such as meetings. That is, location information should also include locations based on activities, such as being in a meeting. Here, the geographic location is less important than the activity. For instance, if on a vacation, traveling on a plane or other such locations identified by activity based identifiers can be used as location-based restrictions, for instance.

The user, in step 250, can choose content restrictions. That is, through voice recognition of incoming telephone calls where a user might be prompted to identify the nature of their business, the content of web pages, emails, SMS and MMS communications, as identified by known technologies, can be used to control access to the individual's communication device. For instance, if the communication is work-related, it might be permitted during working hours and at the same time, for instance, personal communications restricted. During non-working hours, the reverse might be true, for instance.

At step 260, the user can choose communication paths and devices. That is, for certain communications such as voicemail, the voice may be converted to text and sent by SMS or email, for example.

At step 270, the user can choose rules that are either passive or dynamic controls over the various other choices. For instance, if the person's OUTLOOK calendar identifies that they are in a meeting for a given hour, a voice communication might be converted either to an SMS or email so that the individual can review the content of the communication without necessarily answering his phone, and perhaps the text or e-mail message delayed until after the meeting. Of course, a voice mail can be taken and attached to an e-mail or a link to it imbedded in a SMS, as examples. Further, priorities can be assigned, as explained elsewhere, such that for certain content providers (e.g., a family member), the content provider can identify, if entitled to, the priority of the communication. If the communication is that one's child has a broken a bone, a natural disaster, a medical or other emergency, a first or highest priority, for instance, can be assigned so that the telephone rings thereby alerting the user that this is an exceedingly important call and must be answered no matter what other activities are occurring if at all possible, for instance.

As shown in step 280, through the master unit 110, access is controlled based on the chosen user's selections in this embodiment. In step 290, the registered user can be rewarded for using the system and optionally providing personal information.

As optional additional parameters in step 290, the user can select preferred reimbursement/reward modes (e.g., cash via a service such as PayPal, phone credit, music or other media vouchers, favorite charity, credit or discounts, etc.).

This system can be implemented by providing a unique identifier created for that user that links all his delivery channels meaning that the unique identifier can identify landline, his mobile phone, his PDA, his computer tablet, his PC, his laptop and any other communication device he may possess in order to provide a broad range of access controls.

A user can either enter their demographic details or opt to have that information provided via their social network provider such as FACEBOOK, as one example. The demographic data can then be used as part of the rules database so that the user can be incentivized to provide more detailed information which is of more value for advertising targeting by indicating that they will receive more relevant advertisements and offers. In addition, an option exists for a sliding scale of payments per advertisement depending on how much information is provided. This information can be updated, of course, at any time by the users, particularly as the users become more confident of the service and realize the value of receiving targeted but not unduly limited information.

Once registered, the user can control all aspects of content delivery, updating their personal information, preferences, etc. Personal information can be updated from external sources such as social networks, on-line banking, email accounts or otherwise as permitted by the user, for instance. Optional features include that the user can pause delivery for a period of time, suspend indefinitely the delivery of content while maintaining their account on the system for a future date such as during a vacation or opting out by any of his or her chosen communication channels. Reimbursement rates may be adjusted and/or supplementary fees paid if a user takes time to rate the advertisement content either on-line or via telephone. Further, reimbursements can be scaled depending on how much information a user provides both in the sense of demographic data and also time-related information such as information related to the importance to the individual at the present time (e.g., that they are looking for particular goods or service—a car, a refrigerator, a TV, a holiday, a wedding, etc.). This way, events of their life that might be posted on a social network, such as getting married, graduating from school, having a baby, getting a new job, etc., can be utilized to provide content, particularly advertisements. Additional reimbursement may relate to the provision of email addresses, street addresses, permissions to extract for the life-related information from services such as FACEBOOK, etc.

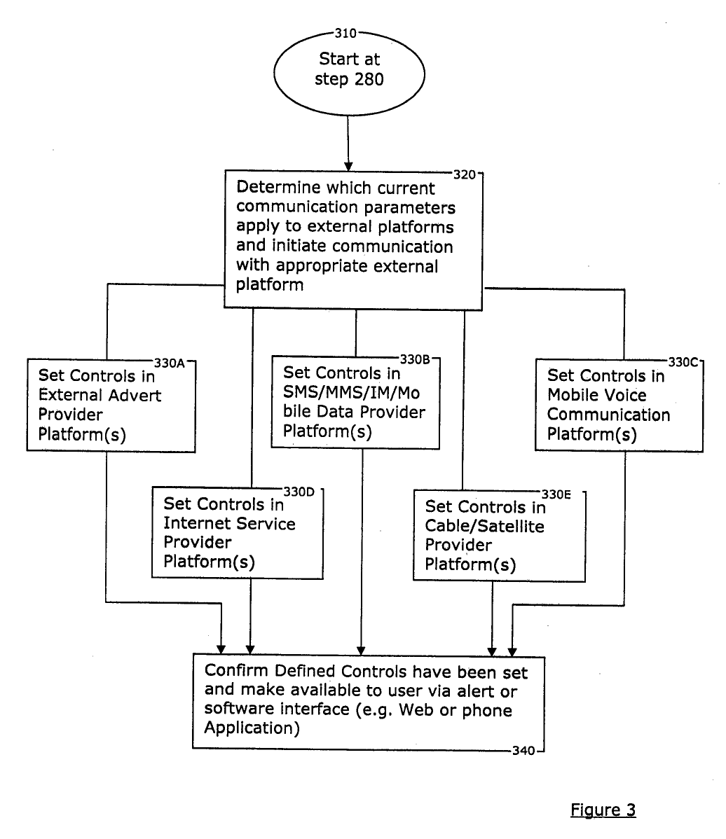

FIG. 3 relates to step 280 of FIG. 2 in that the user-defined controls on the access as found in the master unit 110 can be used to user-defined controls on other platforms. That is, communication outputs 160 may be controlled by the same entity that is, in step 330A, the set user-defined controls can be sent to an advertisement provider platform, which would then use the information to provide advertisements directly to the user communications devices. As shown in step 330B, the user-defined controls can be sent to an SMS/MMS, data providers/email providers in order for those entities to implement the controls within their systems. Similarly, the user-defined controls can be sent to a mobile communications provider, as shown in step 330C, in order to implement the controls. As shown in step 330D, the user-defined controls can be sent to an Internet service provider or gateway server system, for instance, to implement the controls for internet traffic. Likewise, as shown in step 330E, the user-defined controls can be sent to a cable/satellite provider in order for the content, particularly advertisements displayed on the person's television that has a unique identification via a set top box, or the like in order for the user to see content that he or she has authorized when it has been authorized, etc. As shown in step 340, the system can confirm to the user that the user's-defined controls have been sent to the various providers.

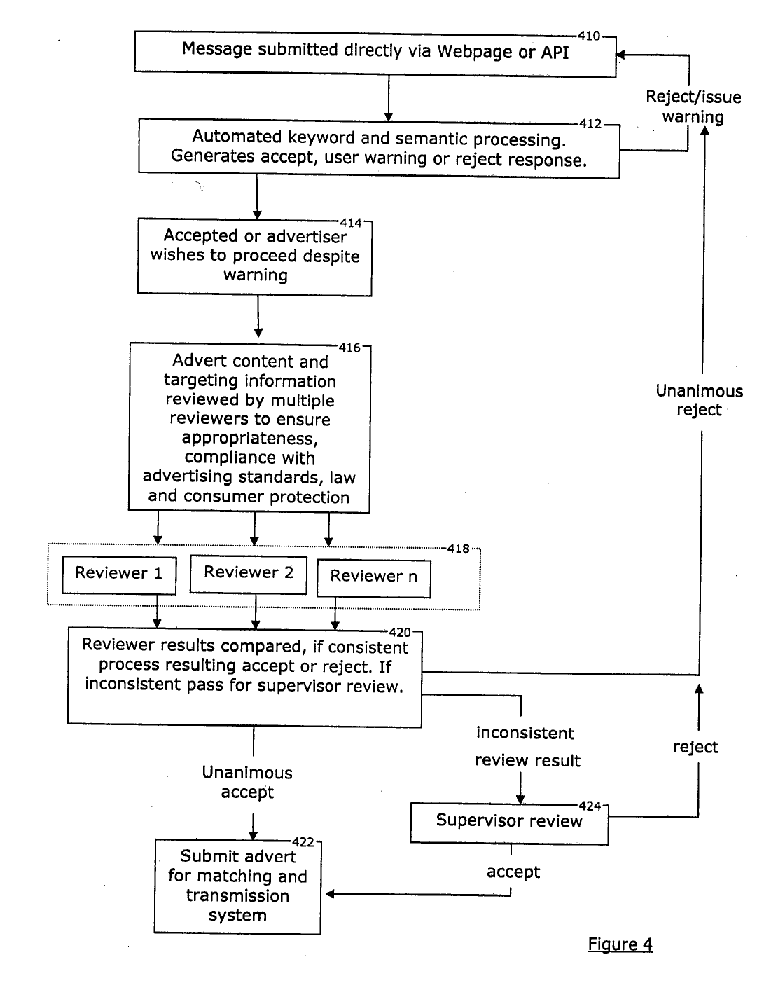

As shown in FIG. 4, there is an advertising approval process that could be implemented. In the illustrated flowchart, the message pre-processing logic involved in submitting an advertising message to the system is demonstrated. The message is submitted directly via webpage or an API, for instance, in step 410. An automated keyword and semantic processing can generate and accept, user warning or reject response in step 412, where appropriate. Where the messages have been accepted or the advertiser wishes to proceed with a warning is determined at step 414 and the advertising content of the targeting information can be reviewed by multiple reviewers to ensure the appropriateness in compliance with advertising standards law and consumer protection regulations as shown in step 416 for distribution to reviewers 1 through n, as shown in step 418. The reviewer results are compared and, if consistent, the process results in acceptance or rejection as step 420. If there is an inconsistent response, the advertisement or other content is passed to a supervisor for review which is conducted at step 424. Whether the reviewer responses are consistent, or the supervisory review has determined to accept the advertisement, the advertisement is then submitted to user profiles and to the transmission system, i.e., the master unit 110 at step 422. Of course, if the advertisement is rejected, in any of these steps, the advertiser is informed preferably through the webpage or API.

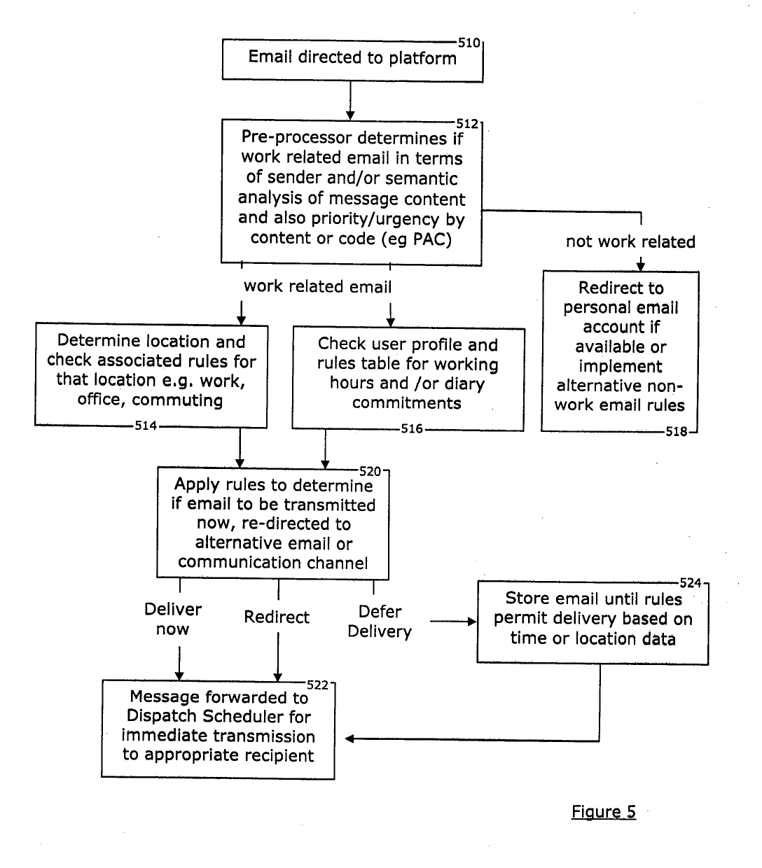

FIG. 5 shows a messaging flow to implement a smart-push email, wherein email is directed to the master unit 510 via the communication inputs 120 as shown in FIG. 1, in step 510. A pre-processor determines if the email is work-related in terms of sender, and/or semantic analysis of the message content and also any indicated priority/urgency, in step 512. If it is not work-related, the email can be redirected to a personal email account and if available or to implement alternative non-work email rules at step 518. If the email is work-related, for instance, then location and associated rules based on location are checked for that particular location at step 514. That is, work-related emails while the person is at work are passed through, whereas work-related emails during commuting times particularly if the individual has indicated that they commute via their own car, are not forwarded at that time, as explained below. At step 516, the user profile is checked and the rules table is also checked for working hours and/or diary commitments. The rules are applied at step 520 to determine if the email is to transmitted now, redirected to an alternative email or alternative communication channel. If the decision is to deliver now or to redirect the email, the message is forwarded to the dispatch scheduler 518 for immediate transmission to the appropriate receiving device via step 522. If the decision is to defer delivery, the email unit rules permit delivery based on a time or location data when it changes to the appropriate criteria, at step 524.

### Implementation Considerations

The gating function required in the implementation of the privacy zone concept can be located in three separate locations providing flexibility in how the service is implemented. Critically this allows the functionality to be initially deployed without requiring modification in any handsets, allowing for a rapid deployment.

Implementation options:
1) Third party stand-alone system;
2) Integrated network provided solution (no handset features); and
3) Integrated handset/network solution

### Third Party Stand-Alone System

In this system a user can use conventional re-direct service to access the enhanced features of the current invention and uses existing handset functionality to change settings while on the move. All the functionality is contained within a standalone platform which merely requires interfaces for text messaging, voice and data communications.

All calls from an existing number are redirected to the incoming interface of the platform. After rule checking calls are forwarded to a new private number or other communication channels as required. Privacy zones can be set by texting keywords to a specific number e.g. the zone colour or words such as Private, Lock. A user could also text location information to a dedicated number or short code e.g. HOME, WORK, GOLF, etc. These can be decoded at the receiving end by the SMS gateway to alter the status and a confirmation text returned to the user if required. Alternatively, a caller can call a service number which can provide a personal or automated system to configure settings. A user can access the configuration settings using existing web access tools on their mobile phone. A dedicated application can be provided on so called ‘smart phones’ such as the iPhone to provide location data from GPS, movement data from embedded sensors in the phone and an option interface.

### Integrated Network Provided Solution (No Handset Features)

This implementation resembles the stand alone service but is implemented within the phone network provider to allow integration of billing and other services. As it can be deployed as a central implementation using existing handset functionality it also allows for rapid deployment.

### Combined Handset and Network (Or Stand-Alone) Solution

When integrated within a handset, a user will be able to set a privacy zone from the menu functions of the handset or via a dedicated button. Data such as GPS location data, motion data, etc. can be transmitted automatically to the central platform (e.g., the master unit 110). Implementation within the handset also allows for visual feedback of privacy zone settings in real time. The zone setting can also be displayed either on the screen or on an independent light emitting source on the phone, or nearly any other sensory indicator, whether indicator light, display indicator/indicia, sensory touch (e.g., vibration at switch state or auditory. Additionally the light source may be colour coded (red, orange, yellow green) to indicate the privacy zone status. Such handset or mobile device enhancements can operate both within a stand-alone system or be integrated into existing phone network's systems. Such functionality can also be implemented in smart phones by downloading a specific application (The Zone Mobile App). This will allow both user input, feedback to user regarding current status and automatic updates from phone sensors such as the microphone, motion detectors or geolocation units such as GPS components. It could also update status and/or send tweets to social networks, if enabled and at the users discretion.

### Specific Embodiment For Mobile Phone Marketing Messages

This embodiment describes the specific advertising and marketing embodiments of the current system.

### Mobile Phone Advertising

Despite the proliferation of advertising, several sectors of modern communications have not developed a truly functional and mature advertising model. The three principal channels that are beset by challenges are:
1) Email.
2) Mobile telephony (voice, text messages (e.g., SMS messages or the equivalent), graphical or multimedia messages (e.g., MMS or equivalent), phone applications)
3) Social Networks

Email marketing has been fundamentally damaged by the unbridled proliferation of spam-emails, i.e. untargeted mass emails for a range of sometimes bizarre products. Email is also rife with fraudulent emails that are designed to look as if they came from a reputable company often in the financial services sector (“phishing”) attacks and other Internet scams.

In mobile telephony the opposite problem has arisen. Government regulation and advertising codes of practice have prohibited unsolicited SMS/MMS messages or marketing calls. In addition compared to the effectively zero cost of sending emails there is a transmission overhead for SMS messages or voice calls. Any SMS/MMS marketing campaign must therefore be opt-in and have the capability to easily opt-out.

A solution for all these channels and other under-exploited communication channels (or others that may be developed in the future) is for a new paradigm in advertising where advertising fees will be used to both cover costs of delivering a message and also to pay the user for accepting them via direct and personal delivery channels. The user can select what sort of products and services they are interested in and be in control of how many messages are delivered and at what times. Advertisers can target the exact demographic they desire and directly deliver messages. This is particularly useful if you are interested in hitting a highly targeted segment in a timely manner. Such a solution is permission based and so avoids the problems of spam, meets the regulatory requirements of SMS/MMS marketing and is optional in social networking settings. Small payments for each advert received will motivate users and overcome the negative reputation of spam and advertising within social networks.

The operation of this new advertising platform involves a number of separate functions that fall under the grouping described above:

### Interface(s) For Incoming Messages

Advertiser registration and campaign setup; and

User response and registration messages via text message or email.

### Message Interrogation and Routing Module

Matching module which dynamically compares all registered users with all active campaigns in real time. This module is operational for both advertising campaign planning and campaign execution; and

Broadcast module which transmits advertising messages to matched recipients according to the time settings of the campaign and the receiving preferences for recipients.

### Interface(s) For Setting, Reviewing and Modifying Routing Rules

User registration and account maintenance;

Advertisement generation, compliance and optimization tools;

Advertisement editorial review; and

Campaign monitoring and reporting.

### Database For Recording Messages, Content Related Data, Rules, User Information and Preferences

Storage of all campaign data, messages, user preferences, etc.; and

Accounting functions for tracking all advertisements charging advertisers and reimbursing users for the ads they have received.

### Outgoing Interface(s) For Message Routing

Sending of text messages;

Sending email messages; and

Automated report delivery of campaigns.

### The User Registration/Account Maintenance Processes Include

A user creates an account either on-line, via a mobile application or via a series of interactive SMS messages. In partnership with mobile operator, the creation of the account could be linked with the creation of the mobile phone account or the purchase of a new phone handset;

A user lists one or more modes for delivery e.g. mobile phone by SMS or “smart application”, email or to a social network account. As discussed below, extensions of the platform could incorporate conventional websites and streamed media such as TV, music of radio broadcasts;

A user selects the preferred reimbursement mode (eg. Cash via services such as PayPal, phone credit, music vouchers, favourite charity, etc.);

A single unique identifier created for that user that links all his delivery channels;

A user can either enter their demographic details or opt to have that information provided via their social network provider e.g. via FACEBOOK. A user can be incentivized to provide more detailed information which is more valuable for advertising targeting by indicating that they will receive more relevant adverts and offers. In addition, an option exists for a sliding scale of payments per advert depending on how much information is provided. This can updated at any time as users becomes more secure with the service;

A user can also opt to receive adverts and offers for specific-types of products and services;

A user has the option to define the times of day he/she is willing receive ads and the maximum per day (which is also subject to control by the company operating the platform);

Once registered, a user can control all aspects of the advert delivery, updating their personal information, preferences, etc. Personal information can be updated from external sources such as social network sites, online banking, email accounts as permitted by the user. Optional features are that a user can pause delivery for a period of time, suspend indefinitely while maintaining their account on the system for a future date (e.g. during vacation) or opt-out by any of his/her chosen communication channels;

Reimbursement rates can be increased or supplementary fees paid if a user takes time to rate an advert either online or via their phone; and

Reimbursements can be scaled depending on how much information a user provides. This can be both demographic and also time related i.e. information about things that are important to them right now such as the fact they are looking to make a purchase of a good or service (e.g. a car, a fridge, a TV, a holiday, a wedding, etc.), they are about to get married, they are about to graduate from college, they are about to have a baby, they have just got a new job, etc. Additional reimbursement may relate to provision and email address, street address or permission to extract life-related information from services such as FACEBOOK.

### The Advertiser Registration and Campaign Management Processes Include

A new advertiser (a company or individual) can register directly online;

An advertiser has the option to test the system within a limited test area so they can see all the functionality before they sign up;

Bank account, pre-pay or credit card information is required to initiate a campaign; and

In setting up a campaign the campaign management module communicates with the advertisement generation, compliance and optimization module and the matching module.

An advertiser can draft their own adverts or use the advert generation tools that can generate appropriate adverts from a set of key points that a advertising wishes to convey e.g. product type, product name, product details, price availability, discount codes, etc. There is also an option for using genetic algorithms to maximise the efficiency of advertisements as described in more detail below.

The advert can contain an optional URL which will only be sent to users that have smartphones (phones with ability to browse the Internet). Such information is gathered on registration or in case of accounts generated on purchase of a phone can be provided by the retailer.

An advertiser can elect the mode of delivery eg. SMS, email, web, etc. They may also wish to send the same message by different modes to reach the maximum audience or send the same message by multiple routes to the same recipient if they wish. If sending complex information it may be appropriate, for example, for a advertiser to send a short text message indicating the nature of the product/offer and say that an email with more details is being sent.

In addition the advertiser can select the demographics and location of the intended audience. The matching module can provide real-time information on the number of available recipients who match that demographic profile and delivery route. The associated costs can also be provided at this stage.

The advertiser can set a budget for each campaign (the maximum number of texts, emails etc.) and plan a time delivery window for execution of the campaign.

Once an advert has been created either by the advertiser or one of the ad generation tools it is processed for compliance both automatically and by transmission to pre-assigned previewers. This transmission process can be remote, e.g., via email or SMS facilitating easy outsourcing. This process ensures adverts comply with policies of the platform provider in regard decency and appropriate language and regulatory requirements eg for alcohol advertising. (see ‘Distributed Advert Compliance System’ below for more detail). Once approved the matching module ensures delivery to the appropriate audience taking into account the up to date preferences for delivery etc

### Campaign Reporting and Monitoring Processes

A campaign reporting and monitoring process involves:

The execution of the campaign in terms of delivery in reported back to the advertisers account management system;

Depending on the type of delivery channel used (e.g., SMS, email etc) response/click through rates are monitored during the delivery process and available for reporting on an advert by advert basis and campaign basis;

A campaign can be paused and modified in mid-execution if certain adverts are performing much better than others. An automated service is also provided to ensure the maximum efficiency of each campaign (see Genetic Algorithms below);

Budgets and delivery demographic requirements can also be updated in real-time; and

In addition to advert delivery and performance data, costs by advert and campaign can be reviewed.

### Accounting Processes Can Include

Each user's internal account is credited with each message received;

After a configurable period (eg hourly, daily, weekly etc) this internal balance is converted into the user's preferred mode of reimbursement eg. cash, phone credit etc assuming they have reached the relevant payment threshold. A user may also elect to initiate such a conversion of their internal balance via web interface at a time of their choosing provided again that they have reached a payment threshold. This avoids payment overheads for a very small reimbursements until a reimbursement has reached the threshold level; and

For each campaign an advertiser must either pay up-front or have established post-payment arrangements (e.g. credit card or bank transfer). Checking of credit status is made during campaign initiation by contacting the accounting module.

### Genetic Algorithm Advertising

The text format of email marketing, SMS advertising or micro-blogging services such as Twitter lend themselves to a novel approach to advertising where adverts are allowed to evolve depending on how effective they are at eliciting a response. As well as maximizing the response from a specific advert, this approach would also provide more general information as to the optimal ad construction in terms of structure and choice of words.

Computer technology allows the tracking of response rates and click-through rates for links. This provides an immediate measure of the effectiveness of an advert or message. If an initial range of for example 10 different messages are sent to several thousand consumers, then based on click-through or response rates the least effective adverts are eliminated. The features and words (especially adjectives) of the most effective are listed by their semantic and syntactic meaning e.g. Computer, noun, synonyms. In the case of a message with several sentences the order could also be varied. These are then recombined in random combinations that respect the language structure of the original message to ensure that the resulting message is grammatically correct and conveys the intended message. This could be achieved by fully automated algorithms or with the aid of a final human proof reading step.

For example take an first draft advert for a new phone. New ZipPhone Released. Available now at MegaCorp stores nationwide from as little as $99. See www.megacorp.com/newzippphone for more details.

This advert has a three sentence structure.

Sentence 1 is the hook or attention grabber with one adjective (‘new’), one noun (‘ZipPhone’) and one verb in the past tense. Sentence 2 provides price and where to buy and sentence 3 provides follow through information with a link to allow tracking of responses. Other sentences that may be included in such an advert include discount offer information (e.g. coupon code or the like) or review information (Voted #1 by PhoneMagazine'). Indeed messages will generally conform to a restrictive range of such structures which are easily defined from existing human generated adverts.

If this advert out of the first batch survived the cut based on response rate then a range of variations could be generated and compared against it to see if a better response rate could be obtained in a direct comparison in a second round. In Sentence 1 synonyms for ‘new’ could be extracted from databases such as WordNet eg ‘latest’. The product name could also be varied by combinations of the manufacturer and model number e.g. MegaCorp's P930 ZipPhone. The verb could be substituted or omitted. Depending nature of the verb the word order could also be revised. e.g. Generated alternatives for sentence 1. Lastest MegaCorp ZipPhone. New ZipPhone launched. Get the new ZipPhone now.

Once the next generation of adverts have been generated they are compared head-to-head by sending out another thousand messages which randomly use one of the previously successful adverts or one of the new generation.

The process is continued until the most successful advert or adverts cannot be bettered in terms of response rate and the response rate has either stabilised or reached the required performance level.

### A More Detailed Description of the Process is as Follows:

To start the process an operator will provide a range of information by category e.g. Product name, product type (e.g. camera, phone, drug), price, discount offers if relevant, where to buy. The operator can then create their own seed advert or let the generation algorithm create one based on the previously established rules for successful adverts;

The seed or seed adverts are processed by a syntactic parser to define the role of each word and sentence structure. Using this generated data and/or the operator inputted data a range of similar adverts are generated by random reassortment that convey the required information in a new manner;

First generation adverts are screened for grammatical sense and if needed regulatory compliance (e.g., in the case of adverts for alcohol);

This first generation are sent out to a statistically valid number of recipients. The audience for the process could either be a genuine sample of consumers from the opt-in database or from predefined testing population (akin to a large distributed focus group) who are recruited for this purpose;

Response rate, click through or other criteria (e.g. user feedback/rating) are used to generate the success (or ‘fitness’ in evolutionary terms) parameter;

Based on the success parameter for each advert the least successful are rejected and the most successful are retained for the next round and also used as the seeds to create the next generation of variations;

Next generation adverts are screened for grammatical sense and, if needed, regulatory compliance (e.g. in the case of adverts for alcohol);

Once the next generation of adverts have been generated they are compared head-to-head by sending out another set of messages a statistically valid number of consumers which randomly use one of the previously successful adverts or one of the new generation; and

The results from one generation are compared to the previous generation or generations. If the response rate or other success criterion has been reached the process can stop and the most successful advert broadcast widely. If not the process reverts to step 5 for the next iteration.

This capability can operate as a sub-feature of the platform or as a stand-alone service for providers or users of other advertising programs, e.g., GOOGLE or YAHOO text adverts.

### Other Areas of Unique Functionality

‘Rate my ad’: Advertisers can ask a particular demographic of users who have agreed to be paid for this service to rate a particular advert or choose between a selection of ads. This provides a human approach to advert optimisation.

‘Straw Poll’: Advertisers can ask a particular demographic users who have agreed to be paid for this service a specific question about their product or service as a rapid form of customer research akin to a distributed focus group. This service can be provided through the same platform with a separate interface for inputting the question or questions required. For example a single topic survey e.g. consumer optimism can be done through SMS. More detailed questionnaires could be performed by email or by directing consumer to a particular website address either by email, SMS or social network message. Collecting data via a website will have the advantage that answers can automatically collated into report format. For SMS responses simple binary or rating questions can be automated but more subjective comment based replies (akin to a twitter survey) will require later collation.

‘Distributed Advert. Compliance System’: To ensure adverts meet regulatory conditions and societal values in relation to choice of words and message it is essential for the advert to be screened. As any advert may be sent to a very large number of people, if any inappropriate advert were dispatched it could have very adverse consequences for the platform operator both in terms of potential fines and damage to reputation. In terms of the rapid advertisement deployment intrinsic to this platform this process must be fast as well as very reliable. This can be achieved very efficiently by a two stage process.

The first automated stage screens out any offensive or blocked keywords akin to an automated spam filter but for each rule that is triggered there is a simple explanation of which words or words are a problem and for what reason. When an advertiser enters the text for a proposed advert it is screened in real time. If there are any problems the rule based stage will flag any problems and the explanation associated with the triggered rule will guide the advertiser in how to redraft the advert. Additional automatic filtering of the advertisement can also be extended to detect premium phone number codes or premium text short codes which may trick a recipient into incurring significant charges on their mobile device. Once the advertiser has an acceptable ad that he/she is satisfied with it can be submitted for final compliance approval.

The second stage is intrinsically subjective and best performed by humans. To ensure reliability and fault tolerance to human error it should be performed by more than one operator. While this will improve reliability of the decision process it would normally slow the process down. To get around this a distributed solution is used as follows:

Each advert for approval is sent simultaneously to a number (e.g. 3-10) of compliance reviewers in the company or outsourced;

They either approve or decline the advert as fast as they can. Any decline messages include the reason for the decline and what change would bring the advert into compliance. This step has built in redundancy as not every reviewer has to respond as long as a predefined number do respond;

All responses are received centrally. If insufficient number of responses have been received within the defined performance window the advert can be sent out to further reviewers. When a sufficient number of responses have been achieved and all replies approve the advert then it is approved and can be transmitted. With the automated pre-screening performed at stage 1 of this process the vast majority of adverts should be approved secure in the knowledge that an error by a single person cannot release an inappropriate advert;

If there are declines the answers are reviewed by a second level reviewer who will be more experienced and will collate the decline reasons or accept the best reason for decline and proposed revision. In cases where a single reviewer has declined and all others have accepted the second level reviewer has the option of over-ruling that single decline and produce an approval; and

Vigilance in a detection task is known to decline as the frequency of the event requiring detection falls. To counter this previously rejected adverts are re-inserted into the approval process at random intervals but at a frequency that ensure maximal vigilance without compromising the overall efficiency (in the order of 2-15%). As well as ensuring vigilance this process allows for validation of individual approvers. Any approver who approves an advert that has been previously been rejected is flagged. Once flagged an approver's performance can be monitored more closely to differentiate between a simple error and a more systematic failure in judgement. More than one failure on such a test advert can initiate suspension from the approval process and re-training. Only on completion of retraining and revalidation is an approver allowed to return to the approval process.

### In Store Voucher or Discount Provision

The platform can deliver advertisements that carry special offers and represent a form of digital voucher. Many solutions exist to redeem vouchers at a point of sale such as barcodes or alphanumeric codes which are scanned or recorded by a vendor. These and any solution for the operation of a promotional voucher can be combined with the functions offered by this invention. Although SMS messages cannot contain bar codes, graphic messages in the form of Multimedia Message System (MMS) can provide this service allowing for codes to be scanned at point of sale. SMS messages are best suited to the delivery of discount codes. If codes or barcodes are not used then an offer can be limited to users of this platform by providing an identifiable marker such as a membership card, key-ring or similar token. This prevents a discount offer within an SMS/MMS message being distributed by a recipient to lots of others so creating a cost overhead to the advertiser which is far greater than anticipated in terms of the number of SMS/MMS advertisements that were dispatched.

### Money Back Promotions

As the platform incorporates the ability to pay recipients for receiving email, an additional feature that can be supported by the platform is unique or time-limited redemption codes which could offer a simple way to have cash back offers on purchase via this reimbursement system. The codes could be limited by number of times they can presented (e.g. from 1 for unique to 10,000), the number of redemptions per user, duration of validity, etc. The system generate codes for the advertiser who disburses them via other media (e.g. in store voucher, email, in product rebate vouchers) and users redeem via text message by texting the code (with or without additional keywords or customer information) to a dedicated short code or standard phone number so it is processed by the platform. On receipt the platform checks to see if the mobile phone number from which it is sent belongs to a member. If so the message is parsed and the code checked for validity and the financial value. The sender can then have their account credited with the appropriate amount. If the user is not a current member then they are invited by text message to enroll from their mobile phone or online.

### Specific Embodiment For Control of Email Communications

A simple application of the current platform is to provide for full control of email delivery and message management to allow protection from work overload, maximize efficiency, ensure email arrives in a controlled manner, provide work home separation while ensuring that important emails are given the priority they deserve. In the future, it is likely that companies will be forced by health and safety legislation or litigation to ensure that employees are not coerced into working excessive hours by delivery of work related emails to mobile devices in an unrestricted manner. The current invention will directly meet that need by providing a range of controls to ensure that messages are delivered only when an employee is within working hours or on company property and that the rate of email delivery prevents information overload while retaining the ability to get urgent messages delivered in a timely fashion.

The operation of the platform to perform email managements is as follows:

### Interface(s) For Incoming Messages

The interface for email handling receives all emails sent to a user at least for registered e-mail accounts. This can be achieved in a number of ways, for example by forwarding all email sent to a user's standard address to a dedicated account with the service provider of the platform. Alternatively, a user may set up a new account to be managed by this service keeping a personal email address only known to close associates. In a corporate setting a company may elect to have all company emails or emails for a defined employee pool routed to the platform.

The incoming message interface will store the message and any attachments. This interface also has the optional ability to store associated message data such sender, routing information, and message content summary via key word or semantic analysis applied to the message, message headers and attachments.

### Message Interrogation and Routing Module

The routing module users the information contained with the email and compares that with the routing rules set-up for the recipient. As with the voice message management application of this platform described above, these rules can provide for open email access or a graded level of access according to time, content, rate of email arrival, source of email, location of recipient at the time, other work priorities e.g. scheduled meetings, etc.

If a message is not to be delivered the sender can be notified by email of this fact to ensure that inappropriate expectations are not generated for a response from the recipient. In addition rather than the inflexible autoresponder messages that currently exist for emails the sender can be given accurate information when a message is likely to be received and indeed when it is actually delivered.

As with the voice communication application the routing module can optionally provide an interaction with the sender requesting more information or a Priority Access Code (PAC) in situations where a critical email is prevented from being immediately delivered. This allows privileged senders high levels of access while preventing a barrage of low level emails which easily divert a person's attention from critical tasks. The routing rules can also allow for messages to be sent via other means e.g. SMS, automated voice message, pager to inform a user that a critical message has been sent by email. The allows a sender to send an email and inform the system of its urgency with a valid code (PAC) and be confident that all available means will be made to ensure the recipient is aware of this.

Message source and content analysis also allows for intelligent redirection of emails to the appropriate person within an organisation if a message could be better dealt with by someone other than the original recipient. Also generic emails, e.g., info@XXXXXcorp.com can be appropriately routed either by content or indeed for global companies by time-zone so that a message is routed to the operational help desk at the time the message is sent.

The routing system can also provide information on how many emails have to be delivered or have been re-routed. This can be delivered as a mini-report delivered to a user by any available specific communication channel.

Although not part of the current invention per se, SPAM and inappropriate emails can be scanned and appropriately deleted or stored within this part of the system to provide a complete email regulation system.

### Interface(s) For Setting, Reviewing and Modifying Routing Rules

Users or companies will be offered an interface that provides for registration, user management and configuration and modification or routing rules. This will typically be provided for by an Internet viewable interface or equivalent computer interface. These rules can relate to wide range of message related or recipient related data, such as sender, message content (key-word or semantic analysis0, presence of PAC, time sent, local time at recipients current location, etc.

As described above additional interfaces will provide for dynamic updates of a user's location (via mobile electronic devices with GPS or other location determining functionality). Applications running on “smart-phones” such as the iPhone can be used to dynamically alter availability to incoming email messages. Work related calendars or scheduling/rostering applications can also be accessed and rules generated to ensure that email is not delivered in a manner that may disrupt meetings or critical work projects. Many of these additional interfaces will be shared with the mobile telephony interface as described above.

### Database For Recording Messages, Content Related Data, Rules, User Information and Preferences

The central database or groups of databases will store all messages, message related data, and routing decisions.

### Outgoing Interface(s) For Message Routing

Most outgoing messages will be in the form of emails so the principal outgoing interface will take the form of an email gateway. As described above there may be situations where a very critical email arrives that the recipient needs to know about as soon as it arrives. In such circumstances the arrival of an email may not only trigger delivery of the email message but also trigger notifications through other outing communication options (SMS, voice, pager, etc.). Reports and notifications may also be delivered by non-email based communication systems.

### Specific Embodiment For Internet Advertising

The above examples indicate the flexibility of the core architecture to control communication delivery from a range of channels to a user by a variety of communication channels. The advertising module described above for mobile telephones can easily be extended to Internet advertising. The core concept of incentivized and personalized content that a user can control has broader application for example for newspapers selling news and content online. The rise of Internet advertising has been associated with a huge loss of advertising revenue for conventional print newspapers. A lot of newspapers have limited free access and a premium full access for users prepared to pay a monthly subscription but this meets a lot of user resistance. They can of course sell advertising and offer the service free but providing too much material free on-line undermines their conventional print business. Using the matching capabilities of this platform, a user could specify their interest in receiving adverts related to their interests and the incentive would be to receive content that would normally be subscription fee only. A central server would then combine content from the newspaper and adverts from the matching module to create online newspaper layouts on the fly. By offering well defined reader interest and demographic information the paper can sell high quality ad slots for more than general web impressions. Potentially this could operate as a stand-alone newspaper which buys in syndicated stories based on topic/keywords to create a personally focused newspaper both in terms ads and editorial content.

The platform could also be used with additional to control delivery of adverts on websites which usually relate to the topic of the webpage in some way but not to the interests of the person viewing them. The webpage lets you know they are interested only in that topic, the matching module of the advertising platform knows all their interests as well as demographic data such as location and income bracket. Standard web page adverts can be identified by their URL links by the advert provider e.g. Google or by the embedded javascript (or similar scripting language) used to pull advert content from an advertisers server as a page is loading. When a request is sent by a user to get a new webpage this is intercepted by the installed advert switching software and each identifiable advert panel is replaced directly by adverts requested from remotely held adverts on the servers operating the matching module functionality. The advertising switching software then presents the altered page to the user's browser. Alternatively the revised page is presented with modified scripting code so that ads are requested by their own browser. The same functionality could also be implemented by use of proxy server. Under this option the user requires only to run a configuration program (or procedure) once and all subsequent Internet requests are routed initially through this proxy server. This server would identify the user by IP address or similar unique identifier. This server would request the requested content from a website and then reformat in a similar fashion but with relevant adverts requested via the the matching module.

### Specific Embodiment For Television and Radio Advertising

Modification of the same approach also allows application to any form of streaming content e.g. music, television or radio/podcast. Users can be incentivized to receive adverts by having access to media content that would normally require one-off payment or a subscription. Imagine a world where nearly all content e.g. radio, TV and web are digitally delivered and there could be an option whereby you could pay a premium each month not to receive adverts or be effectively paid by discount up to the point where the service is free if you receive ads, the added advantage is that they only things you are interested in. The streaming technology of such a service could have tags that mark where adverts can be inserted. For the premium service no adverts are inserted into the stream, but if a user has selected an advertising supported free or discounted version adverts appropriate to that viewer (or household) are inserted as required. An alternative is where similar technology strips out all ads where a user is a premium subscription payer who has elected to pay for content directly rather than via an advertising supported model. Such as user can then experience full access to streamed media content with no adverts.

The present invention has been described by way of exemplary embodiments to which it is not limited. Variations and modifications will occur to those skilled in the art without departing from the present invention as defined in the claims appended hereto. As to the claims, “comprising” should be interpreted as an open-ended transitional phrase. Also, those skilled in the art will realize that storage devices utilized to store program instructions and data can be distributed across a network, and stored on one or a plurality of tangible memory devices. Those skilled in the art will also realize that by utilizing conventional techniques known to those skilled in the art that all or a portion of the software instructions may be carried out by a dedicated circuit, such as a DSP, programmable logic array, or the like. Further, the steps of the disclosed methods can be modified in any manner, including by reordering steps and/or inserting or deleting steps, without departing from the principles of the invention. It is therefore intended that the specification and embodiments be considered as exemplary only.

What is claimed is:

1. A method of permitting a user to control communication access to user, comprising:
registering a user;
registering at least one user communications device capable of receiving device-based communications;
receiving user-defined parameters from a registered user, said user-defined parameters setting controls on access for communications to said at least one user communications device, said parameters including at least two of:
at least one selection of content provider parameters,
at least one selection of times period parameters,
at least one selection of location parameters,
at least one selection of content parameters,
at least one selection of registered user communications devices when more than one user communications device is registered,
at least one selection of a communication route parameters when more than one route is available to a registered user communications device, and
at least one selection of interrelationship controls or dynamic controls on said selected parameters; and
controlling access to said registered user communications device in accordance with said selected user-defined parameters that set controls on access for communications to said registered user communications device.

2. The method of claim 1, wherein said selection of content provider parameters includes selecting what individuals or other entities can have access to a selected user-device.

3. The method of claim 1, wherein said selection of interrelationship control parameters includes assigning a priority to said selected content providers.

4. The method of claim 1, wherein said selection of time period parameters includes selecting times of day, days, months or years, or combinations thereof.

5. The method of claim 1, wherein said selection of time period parameters includes selecting times of day according to days of week, day of month or days of year.

6. The method of claim 1, wherein said selection of location parameters includes selecting locations where communication is restricted or selected locations where communications are unrestricted, or both.

7. The method of claim 1, wherein said restrictions on communications includes blocking, re-routing, delaying or permitting only communications of a threshold priority.

8. The method of claim 1, wherein said selection of content includes at least one of selection of topic as determined by text analysis or speech analysis, classification, or an identified priority level.

9. The method of claim 1, wherein said selection of dynamic controls includes selection of how many communications will be accepted in a given time period, at a given location, by a given content provider, on a given registered user communications device, or though a given communications route.

10. The method of claim 1, further comprising providing an automated response to a sender indicating the likely for time frame for a recipient user to reply to a given communication.

11. The method of claim 1, wherein each of said content provider parameters, times period parameters, location parameters, content parameters, registered user communications devices parameters when more than one user communications device is registered, communication route parameters, whereby a user can control who can access said registered user communications device, what content can be received, when communications can be received, where communications can be received and how can be received.

12. The method of claim 1, further comprising rewarding a user for making said selections, or providing personal demographic data, or both, and agreeing to receive advertising content.

13. The method of claim 12, wherein said step of receiving user-defined parameters from a registered user includes receiving at least one user-defined parameter regarding the manner in which the user is rewarded from a group of reward parameters comprising: cash or cash equivalents, credit, pre-loaded fund cards, premium subscription or subscriptions, vouchers, premium media content and discounts for products or services.

14. The method of claim 1, wherein when communication content includes advertising messages, said message content is controlled by (1) categories, classifications or topics chosen by the user; (2) demographics, income, job or related interest of the user; or combinations of elements of (1) and (2).

15. The method of claim 14, wherein said elements of (1) and (2) are dynamically configured on the basis information from user posts on social networking sites, location, search or browsing history.

16. The method of claim 1, further comprising:
receiving from a user an exclusion zone for advertisements within media content such that received media content has been automatically stripped of advertising; and
receiving an indication from said user parameters defining of how blank space removed from the media content is to be filled with at least one of background, family photos, video from a designated video library or online source, when an audio advertisement music from a selected music library, content from other selected providers, or other advertisement content the user is interested in receiving.

17. One or more computer-readable media storing computer-executable instructions for performing the following steps:
registering a user;
registering at least one user communications device capable of receiving device-based communications;
receiving user-defined parameters from a registered user, said user-defined parameters setting controls on access for communications to said at least one user communications device, said parameters including at least two of:
at least one selection of content provider parameters,
at least one selection of times period parameters,
at least one selection of location parameters,
at least one selection of content parameters,
at least one selection of registered user communications devices when more than one user communications device is registered,
at least one selection of a communication route parameters when more than one route is available to a registered user communications device, and
at least one selection of interrelationship controls or dynamic controls on said selected parameters; and
controlling access to said registered user communications device in accordance with said selected user-defined parameters that set controls on access for communications to said registered user communications device.

18. An apparatus, comprising:
means for registering a user;
means for registering at least one user communications device capable of receiving device-based communications;
means for receiving user-defined parameters from a registered user, said user-defined parameters setting controls on access for communications to said at least one user communications device, said parameters including at least two of:
at least one selection of content provider parameters,
at least one selection of times period parameters,
at least one selection of location parameters,
at least one selection of content parameters,
at least one selection of registered user communications devices when more than one user communications device is registered,
at least one selection of a communication route parameters when more than one route is available to a registered user communications device, and
at least one selection of interrelationship controls or dynamic controls on said selected parameters; and
means for controlling access to said at least one registered user communications device in accordance with said selected user-defined parameters that set controls on access for communications to said at least one registered user communications device.

19. An apparatus, comprising:
a user registration device that receives user information to register a user;
a user communications device registration device that receives user communications device registration to register at least one device capable of receiving device-based communications in relation to said user;
a parameter setting device that receives user-defined parameters from a registered user, said user-defined parameters setting controls on access for communications to said at least one user communications device, said parameters including at least two of:
at least one selection of content provider parameters,
at least one selection of times period parameters,
at least one selection of location parameters,
at least one selection of content parameters,
at least one selection of registered user communications devices when more than one user communications device is registered,
at least one selection of a communication route parameters when more than one route is available to a registered user communications device, and
at least one selection of interrelationship controls or dynamic controls on said selected parameters; and
an access control device controlling access to said at least one registered user communications device in accordance with said selected user-defined parameters that set controls on access for communications to said at least one registered user communications device.
